(19) United States
(12) Patent Application Publication
(10) Pub. No.: US 2014/0119446 A1
(43) Pub. Date: May 1, 2014

(54) PRESERVING ROUNDING ERRORS IN VIDEO CODING

(71) Applicant: MICROSOFT CORPORATION, Redmond, WA (US)

(72) Inventor: Lazar Bivolarsky, Cupertino, CA (US)

(73) Assignee: MICROSOFT CORPORATION, Redmond, WA (US)

(21) Appl. No.: 13/666,839

(22) Filed: Nov. 1, 2012

(51) Int. Cl. H04N 7/32

(52) U.S. Cl. 375/240.16; 375/E07.243

(57) ABSTRACT

An input receives a video signal comprising a plurality of frames of a video image, each frame comprising a plurality of higher resolution samples. A projection generator generates a different respective projection of each of a sequence of the frames, each projection comprising a plurality of lower resolution samples, wherein the lower resolution samples of the different projections represent different but overlapping groups of the higher resolution samples which overlap spatially in a plane of the video image. Inter frame prediction coding is performed between the projections of different ones of the frames based on a motion vector for each prediction. The motion vector is scaled down from a higher resolution scale corresponding to the higher resolution samples to a lower resolution scale corresponding to the lower resolution samples. An indication of a rounding error resulting from this scaling is determined and signalled to the receiving terminal.

### BACKGROUND

In the past, the technique known as “super resolution” has been used in satellite imaging to boost the resolution of the captured image beyond the intrinsic resolution of the image capture element. This can be achieved if the satellite (or some component of it) moves by an amount corresponding to a fraction of a pixel, so as to capture samples that overlap spatially. In the region of overlap, a higher resolution sample can be generated by extrapolating between the values of the two or more lower resolution samples that overlap that region, e.g. by taking an average. The higher resolution sample size is that of the overlapping region, and the value of the higher resolution sample is the extrapolated value.

The idea is illustrated schematically in FIG. 1. Consider the case of a satellite having a single square pixel P which captures a sample from an area of 1 km by 1 km on the ground. If the satellite then moves such that the area captured by the pixel shifts half a kilometre in a direction parallel to one of the edges of the pixel P, and then takes another sample, the satellite then has available two samples covering the overlapping region P′ of width 0.5 km. As this process progresses with samples being taken at 0.5 km intervals in the direction of the shift, and potentially also performing successive sweeps offset by half a pixel perpendicular to the original shift, it is possible to build up an image of resolution 0.5 km by 0.5 km, rather than 1 km by 1 km. It will be appreciated this example is given for illustrative purposes—it is also possible to build up a much finer resolution and to do so from more complex patterns of motion.

More recently the concept of super resolution has been proposed for use in video coding. One potential application of this is similar to the scenario described above—if the user's camera physically shifts between frames by an amount corresponding to a non-integer number of pixels (e.g. because it is a handheld camera), and this motion can be detected (e.g. using a motion estimation algorithm or motion sensors), then it is possible to create an image with a higher resolution than the intrinsic resolution of the camera's image capture element by extrapolating between pixel samples where the pixels of the two frames partially overlap.

Another potential application is to deliberately lower the resolution of each frame and introduce an artificial shift between frames (as opposed to a shift due to actual motion of the camera). This enables the bit rate per frame to be lowered. Referring to FIG. 2, say the camera captures pixels P′ of a certain higher resolution (possibly after an initial quantization stage). Encoding at that resolution in every frame F would incur a certain bitrate. In a first frame F(t) at some time t, the encoder therefore creates a lower resolution version of the frame having pixels of size P, and transmits and encodes these at the lower resolution. For example in FIG. 2 each lower resolution pixel is created by averaging the values of four higher resolution pixels. In the subsequent frame F(t+1), the encoder does the same but with the raster shifted by a fraction of one of the lower resolution pixels, e.g. half a pixel in the horizontal and vertical directions in the example shown. At the decoder, a higher resolution pixel size P′ can then be recreated again by extrapolating between the overlapping regions of the lower resolution samples of the two frames. More complex shift patterns are also possible. For example the pattern may begin at a first position in a first frame, then shift the raster horizontally by half a (lower resolution) pixel in a second frame, then shift the raster in the vertical direction by half a pixel in a third frame, then back by half a pixel in the horizontal direction in a fourth frame, then back in the vertical direction to repeat the cycle from the first position. In this case there are four samples available to extrapolate between at the decoder for each higher resolution pixel to be reconstructed.

### SUMMARY

Embodiments of the present invention receive an input video signal comprising a plurality of frames of a video image, each frame comprising a plurality of higher resolution samples. A different respective “projection” is then generated for each of a sequence of said frames. Each projection comprises a plurality of lower resolution samples, wherein the lower resolution samples of the different projections represent different but overlapping groups of the higher resolution samples which overlap spatially in a plane of the video image. The video signal is encoded into one or more encoded streams, and transmitted to a receiving terminal over a network.

The encoding comprises inter frame prediction coding between the projections of different ones of the frames based on a motion vector for each prediction. This also comprises scaling down the motion vector from a higher resolution scale corresponding to the higher resolution samples to a lower resolution scale corresponding to the lower resolution samples. Further, an indication of a rounding error resulting from said scaling is determined. This indication of the rounding error is signalled to the receiving terminal.

Other embodiments of the present invention are for decoding a video signal comprising a plurality of frames of a video image. A video signal is received from a transmitting terminal over a network, the video signal comprising multiple different projections of the video image. Each projection comprises a plurality of lower resolution samples, wherein the lower resolution samples of the different projections represent different but overlapping portions which overlap spatially in a plane of the video image. The video signal is decoded so as to decode the projections. Higher resolution samples are then generated representing the video image at a higher resolution. This is achieved by, for each higher resolution sample thus generated, forming the higher resolution sample from a region of overlap between ones of the lower resolution samples from the different projections. The video signal is output to a screen at the higher resolution following generation from the projections.

The decoding comprises inter frame prediction between the projections of different ones of the frames based on a motion vector received from the transmitting terminal for each prediction. This also comprises scaling up the motion vector for use in the prediction from a lower resolution scale corresponding to the lower resolution samples to a higher resolution scale corresponding to the higher resolution samples. Further, a rounding error is received from the transmitting terminal, and this rounding error is incorporated when performing said scaling up of the motion vector.

The various embodiments may be embodied at a transmitting terminal, receiving terminal system, or as computer program code to be run at the transmitting or receiving side, or may be practiced as a method. The computer program may be embodied on a computer-readable medium. The computer-readable may be a storage medium.

### BRIEF DESCRIPTION OF THE DRAWINGS

For a better understanding of the various embodiments and to show how they may be put into effect, reference is made by way of example to the accompanying drawings in which:

FIG. 1 is a schematic representation of a super resolution scheme,

FIG. 2 is another schematic representation of a super resolution scheme,

FIG. 3 is a schematic block diagram of a communication system,

FIG. 4 is a schematic block diagram of an encoder,

FIG. 5 is a schematic block diagram of a decoder,

FIG. 6 is a schematic representation of an encoding system,

FIG. 7 is a schematic representation of a decoding system,

FIG. 8 is a schematic representation of an encoded video signal comprising a plurality of streams,

FIG. 9 is a schematic illustration of motion prediction between two frames,

FIG. 10 is a schematic illustration of motion prediction over a sequence of frames,

FIG. 11 is a schematic representation of the addition of a motion vector with a super resolution shift, and

FIG. 12 is another schematic representation of a video signal to be encoded.

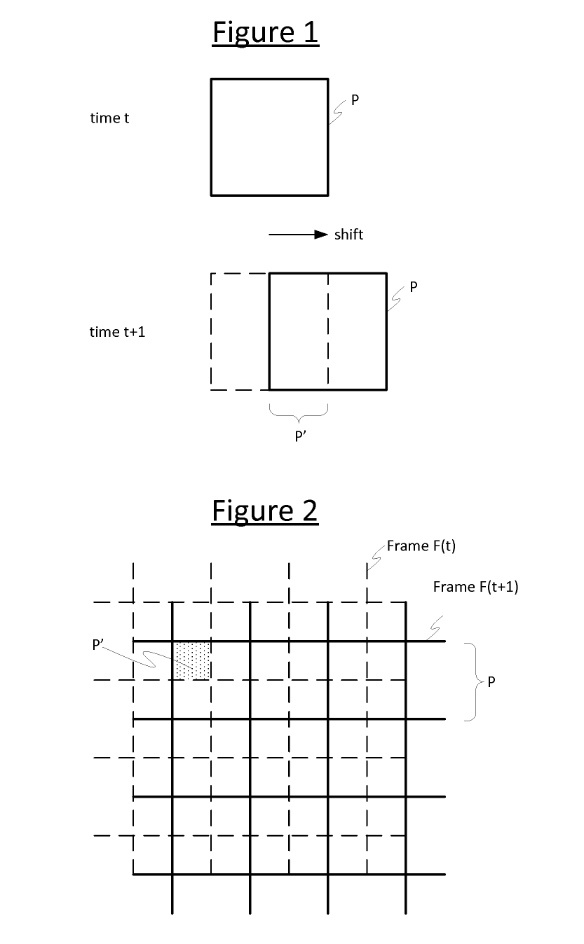

### DETAILED DESCRIPTION

Embodiments of the present invention provide a super-resolution based compression technique for use in video coding. Over a sequence of frames, the image represented in the video signal is divided into a plurality of different lower resolution “projections” from which a higher resolution version of the frame can be reconstructed. Each projection is a version of a different respective one of the frames, but with a lower resolution than the original frame. The lower resolution samples of each different projection have different spatial alignments relative to one another within a reference grid of the video image, so that the lower resolution samples of the different projections overlap but are not coincident. For example each projection is based on the same raster grid defining the size and shape of the lower resolution samples, but with the raster being applied with a different offset or “shift” in each of the different projections, the shift being a fraction of the lower resolution sample size in either the horizontal and/or vertical direction relative to the raster orientation. Each frame is subdivided into only one projection regardless of shift step, e.g. ½ or ¼ pixel.

An example is illustrated schematically in FIG. 12. Illustrated at the top of the page is a video signal to be encoded, comprising a plurality of frames F each representing the video image at successive moments in time t, t+1, t+2, t+3 . . . (where time is measured as a frame index and t is any arbitrary point in time).

A given frame F(t) comprises a plurality of higher resolution samples S′ defined by a higher resolution, raster shown by the dotted grid lines in FIG. 12. A raster is a grid structure which when applied to a frame divides it into samples, each sample being defined by a corresponding unit of the grid. Note that a sample does not necessarily mean a sample of the same size as the physical pixels of the image capture element, nor the physical pixel size of a screen on which the video is to be output.

For example, samples could be captured at an even higher resolution, and then quantized down to produce the samples S′.

Each of a sequence of frames F(t), F(t+1), F(t+2), F(t+3) is then converted into a different respective projection (a) to (d). Each of the projections of comprises a plurality of lower resolution samples S defined by applying a lower resolution raster to the respective frame, as illustrated by the solid lines overlaid on the higher resolution grid of in FIG. 12. Again the raster is a grid structure which when applied to a frame divides it into samples. Each lower resolution sample S represents a group of the higher resolution samples S′, with the grouping depending on the grid spacing and alignment of the lower resolution raster, each sample being defined by a corresponding unit of the grid. The grid may be a square or rectangular grid, and the lower resolution samples may be square or rectangular in shape (as are the higher resolution samples), though that does not necessarily have to be the case. In the example shown, each lower resolution sample S covers a respective two-by-two square of four higher resolution samples S′. Another example would be a four-by-four square of sixteen.

Each lower resolution sample S represents a respective group of higher resolution samples S′ (each lower resolution sample covers a whole number of higher resolution samples). The value of the lower resolution sample S may be determined by combining the values of the higher resolution samples, for example by taking an average such as a mean or weighted mean (although more complex relationships are not excluded). Alternatively the value of the lower resolution sample could be determined by taking the value of a representative one of the higher resolution samples, or averaging a representative subset of the higher resolution values.

The grid of lower resolution samples in the first projection (a) has a certain, first alignment relative to the underlying higher-resolution raster of the video image represented in the signal being encoded, in the plane of the frame. For reference this may be referred to here as a shift of (0, 0). The grid of lower resolution samples formed by each further projection (b) to (d) of the subsequent frames F(t+1), F(t+2), F(t+3) respectively is then shifted by a different respective amount in the plane of the frame. For each successive projection, the shift is by a fraction of the lower resolution sample size in the horizontal or vertical direction. In the example shown, in the second projection (b) the lower resolution grid is shifted right by half a (lower resolution) sample, i.e. a shift of (+½, 0) relative to the reference position (0, 0). In the third projection (c) the lower resolution grid is shifted down by another half a sample, i.e. a shift of (0, +½) relative to the second shift or a shift of (+½, +½) relative to the reference position. In the fourth projection the lower resolution grid is shifted left by another half a sample, i.e. a shift of (−½, 0) relative to the third projection or (0, +½) relative to the reference position. Together these shifts make up a shift pattern.

In FIG. 12 this is illustrated by reference to a lower resolution sample S(m, n) of the first projection (a), where m and n are coordinate indices of the lower resolution grid in the horizontal and vertical directions respectively, taking the grid of the first projection (a) as a reference. A corresponding, shifted lower resolution sample being a sample of the second projection (b) is then located at position (m, n) within its own respective grid which corresponds to position (m+½, n) relative to the first projection. Another corresponding, shifted lower resolution sample being a sample of the third projection (c) is located at position (m, n) within the respective grid of the third projection which corresponds to position (m+½, n+½) relative to the grid of the first projection. Yet another corresponding, shifted lower resolution sample being a sample of the fourth projection (d) is located at its own respective position (m, n) which corresponds to position (m, n+½) relative to the first projection. Each projection is formed in a different respective frame.

The value of the lower resolution sample in each projection is taken by combining the values of the higher resolution samples covered by that lower resolution sample, i.e. by combining the values of the respective group of lower resolution samples which that higher resolution sample represents. This is done for each lower resolution sample of each projection based on the respective groups, thereby generating a plurality of different reduced-resolution versions of the image over a sequence of frames.

The pattern repeats over multiple sequences of frames. The projection of each frame is encoded and sent to a decoder in an encoded video signal, e.g. being transmitted over a packet-based network such as the Internet. Alternatively the encoded video signal may be stored for decoding later by a decoder.

At the decoder, the different projections of the sequence of frames can then be used reconstruct a higher resolution sample size from the overlapping regions of the lower resolution samples. For example, in the embodiment described in relation to FIG. 12, any group of four overlapping samples from the different projections defines a unique intersection. The shaded region S′ in FIG. 12 corresponds to the intersection of the lower resolution samples S(m, n) from projections (a), (b), (c) and (d). The value of the higher resolution sample corresponding to this overlap or intersection can be found by extrapolating between the values of the lower resolution samples that overlap at the region in question, e.g. by taking an average such as a mean or weighted mean. Each of the other higher resolution samples can be found from a similar intersection of lower resolution samples.

Over a sequence of frames the video image may be subdivided into a full set of projections, e.g. when the shift is half a sample there are provided four projections over a sequence of four frames, and in the case of a quarter shift sixteen projections over sixteen frames. Therefore overall, the frame including all its projections together may still recreate the same resolution as if the super resolution technique was not applied, albeit taking longer to build up that resolution.

However, the video image is broken down into separate descriptions, which can be manipulated separately or differently. There are a number of potentially advantageous uses for the division of the video into multiple projections, for example as follows.
Each projection may be encoded separately as an individual stream. At least one or some, and potentially all, of the projections are encoded in their own right, not relative to any other one of the streams, i.e. are independently decodable.
Following from this, to enhance robustness the different projections may be sent as separate respective streams over the network. Thus if one or some of the streams are lost in transmission, or deliberately dropped, the decoder can still recreate at least a lower resolution version of the video from the one or more streams that remain.
There is provided a new opportunity for scaling by omitting or dropping one or more projections, i.e. a new form of layered coding.
The number of bits incurred in the encoded signal per frame is reduced.

Note also that, in embodiments, the multiple projections are created by a predetermined shift pattern, not signalled over the network from the encoder to the decoder and not included in the encoded bitstream. The order of the projection may determine the shift position in combination with the shift pattern. That is, each of said projections may be of a different respective one of a sequence of said frames, and the projection of each of said sequence of frames may be a respective one of a predetermined pattern of different projections, wherein said pattern repeats over successive sequences of said frames. The decoder is then configured to regenerate a higher resolution version of the video based on the predetermined pattern being pre-stored or pre-programmed at the receiving terminal rather than received from the transmitting terminal in any of the streams.

However, there is an issue that may occur with signalling the motion vector when frames converted into lower resolution projections are encoded using inter prediction coding (i.e. motion prediction). To encode a lower resolution projection, a motion vector is shrunk from a higher resolution scale to a lower resolution scale. However, it may be assumed at the decoder that motion estimation was done by the encoder on the higher resolution scale, so the decoder will need the higher resolution motion vector to perform reconstruction. When the motion vector is shrunk from a higher resolution scale to a lower resolution scale at the encoder and then scaled back up to the higher resolution scale at the decoder, then a rounding error will be introduced.

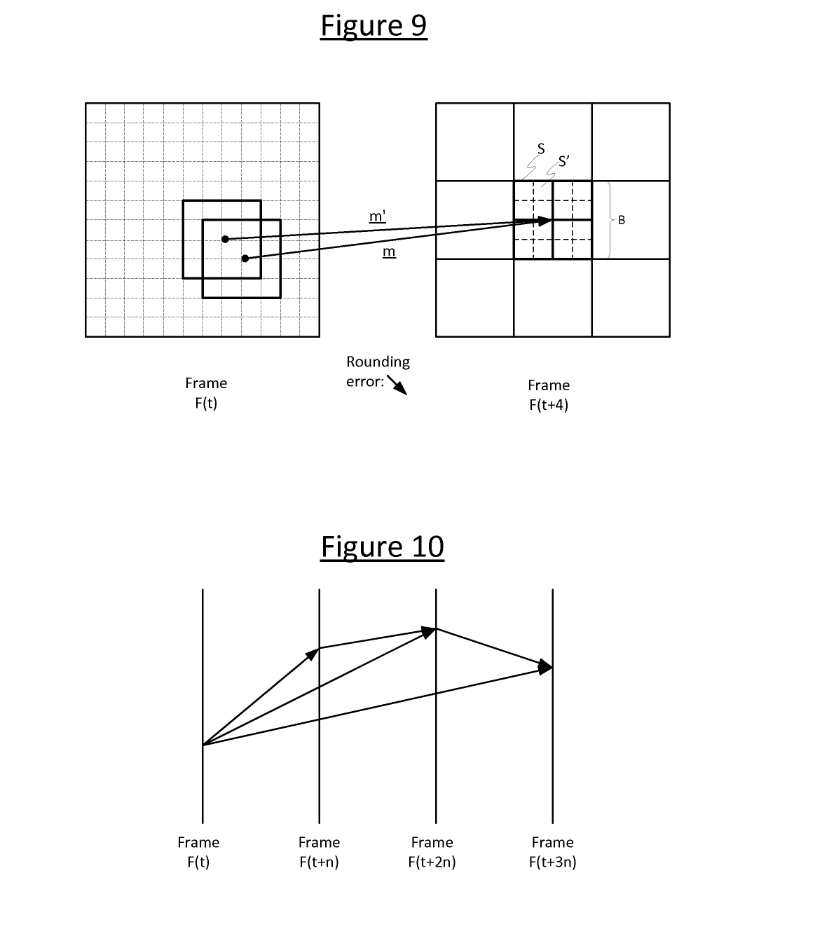

This rounding error may be tolerable between two frames, but when the error propagates over multiplied frames then it may become a problem. This issue is to be addressed by the following described embodiments of the present invention, illustrated with reference to the examples of FIGS. 9 and 10.

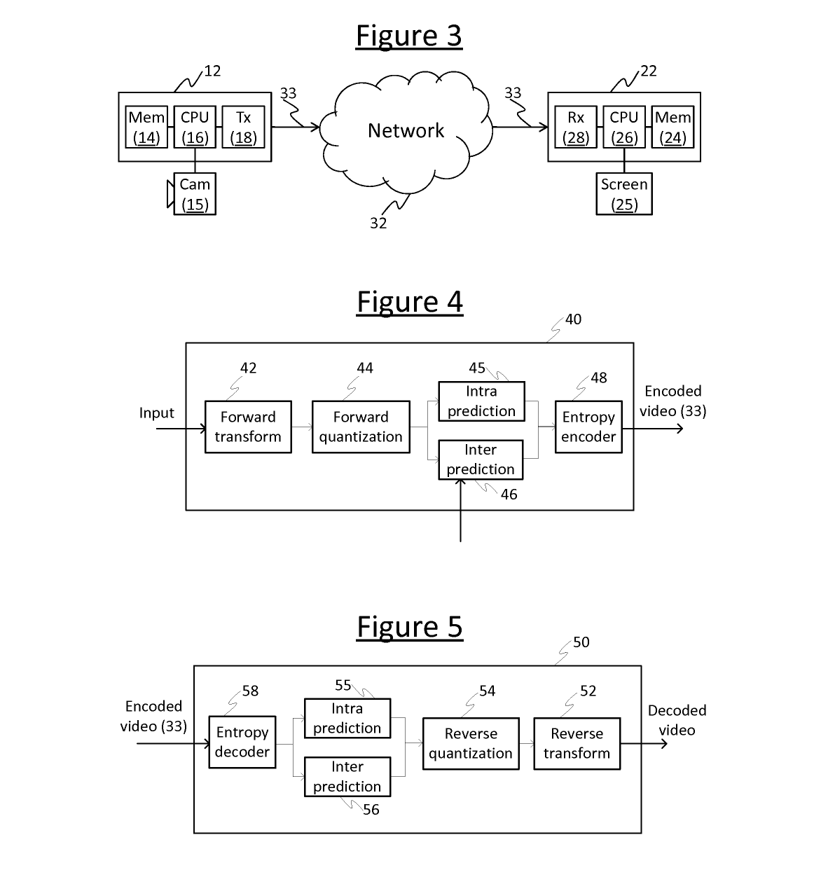

First an example communication system in which the various embodiments may be employed is described with reference to the schematic block diagram of FIG. 3.

The communication system comprises a first, transmitting terminal 12 and a second, receiving terminal 22. For example, each terminal 12, 22 may comprise one of a mobile phone or smart phone, tablet, laptop computer, desktop computer, or other household appliance such as a television set, set-top box, stereo system, etc. The first and second terminals 12, 22 are each operatively coupled to a communication network 32 and the first, transmitting terminal 12 is thereby arranged to transmit signals which will be received by the second, receiving terminal 22. Of course the transmitting terminal 12 may also be capable of receiving signals from the receiving terminal 22 and vice versa, but for the purpose of discussion the transmission is described herein from the perspective of the first terminal 12 and the reception is described from the perspective of the second terminal 22. The communication network 32 may comprise for example a packet-based network such as a wide area internet and/or local area network, and/or a mobile cellular network.

The first terminal 12 comprises a computer-readable storage medium 14 such as a flash memory or other electronic memory, a magnetic storage device, and/or an optical storage device. The first terminal 12 also comprises a processing apparatus 16 in the form of a processor or CPU having one or more cores; a transceiver such as a wired or wireless modem having at least a transmitter 18; and a video camera 15 which may or may not be housed within the same casing as the rest of the terminal 12. The storage medium 14, video camera 15 and transmitter 18 are each operatively coupled to the processing apparatus 16, and the transmitter 18 is operatively coupled to the network 32 via a wired or wireless link. Similarly, the second terminal 22 comprises a computer-readable storage medium 24 such as an electronic, magnetic, and/or an optical storage device; and a processing apparatus 26 in the form of a CPU having one or more cores. The second terminal comprises a transceiver such as a wired or wireless modem having at least a receiver 28; and a screen 25 which may or may not be housed within the same casing as the rest of the terminal 22. The storage medium 24, screen 25 and receiver 28 of the second terminal are each operatively coupled to the respective processing apparatus 26, and the receiver 28 is operatively coupled to the network 32 via a wired or wireless link.

The storage medium 14 on the first terminal 12 stores at least a video encoder arranged to be executed on the processing apparatus 16. When executed the encoder receives a “raw” (unencoded) input video signal from the video camera 15, encodes the video signal so as to compress it into a lower bitrate stream, and outputs the encoded video for transmission via the transmitter 18 and communication network 32 to the receiver 28 of the second terminal 22. The storage medium on the second terminal 22 stores at least a video decoder arranged to be executed on its own processing apparatus 26. When executed the decoder receives the encoded video signal from the receiver 28 and decodes it for output to the screen 25. A generic term that may be used to refer to an encoder and/or decoder is a codec.

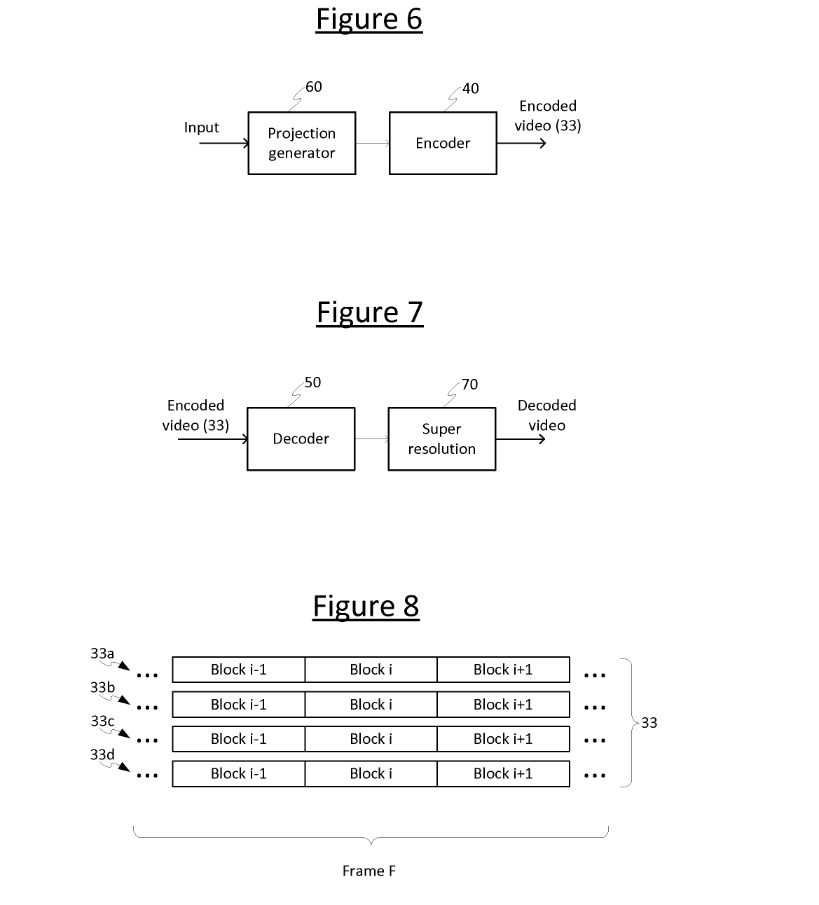

FIG. 6 gives a schematic block diagram of an encoding system that may be stored and run on the transmitting terminal 12. The encoding system comprises a projection generator 60 and an encoder 40, for example being implemented as modules of software (though the option of some or all of the functionality being implemented in dedicated hardware circuitry is not excluded). The projection generator has an input arranged to receive an input video signal from the camera 15, comprising series of frames to be encoded as illustrated at the top of FIG. 12. The encoder 40 has an input operatively coupled to an output of the projection generator 60, and an output arranged to supply an encoded version of the video signal to the transmitter 18 for transmission over the network 32.

FIG. 4 gives a schematic block diagram of the encoder 40. The encoder 40 comprises a forward transform module 42 operatively coupled to the input from the projection generator 60, a forward transform module 44 operatively coupled to the forward transform module 42, an intra prediction coding module 45 and an inter prediction (motion prediction) coding module 46 each operatively coupled to the forward quantization module 44, and an entropy encoder 48 operatively coupled to the intra and inter prediction coding modules 45 and 46 and arranged to supply the encoded output to the transmitter 18 for transmission over the network 32.

In operation, the projection generator 60 sub-divides the input video signal into a plurality of projections, generating a respective projection for each successive frame as discussed above in relation to FIG. 12.

Each projection may be individually passed through the encoder 40 and treated as a separate stream. For encoding each projection may be divided into a plurality of blocks (each the size of a plurality of the lower resolution samples S).

Within a given projection, the forward transform module 42 transforms each block from a spatial domain representation into a transform domain representation, typically a frequency domain representation, so as to convert samples of the block to a set of transform domain coefficients. Examples of such transforms include a Fourier transform, a discrete cosine transform (DCT) and a Karhunen-Loève transform (KLT) details of which will be familiar to a person skilled in the art. The transformed coefficients of each block are then passed through the forward quantization module 44 where they are quantized onto discrete quantization levels (coarser levels than used to represent the coefficient values initially). The transformed, quantized blocks are then encoded through the prediction coding stage 45 or 46 and then a lossless encoding stage such as an entropy encoder 48.

The effect of the entropy encoder 48 is that it requires fewer bits to encode smaller, frequently occurring values, so the aim of the preceding stages is to represent the video signal in terms of as many small values as possible.

The purpose of the quantizer 44 is that the quantized values will be smaller and therefore require fewer bits to encode. The purpose of the transform is that, in the transform domain, there tend to be more values that quantize to zero or to small values, thereby reducing the bitrate when encoded through the subsequent stages.

The encoder may be arranged to encode in either an inter prediction coding mode or an inter prediction coding mode (i.e. motion prediction). If using inter prediction, the inter prediction module 46 encodes the transformed, quantized coefficients from a block of one frame F(t) relative to a portion of a preceding frame F(t−1). The block is said to be predicted from the preceding frame. Thus the encoder only needs to transmit a difference between the predicted version of the block and the actual block, referred to in the art as the residual, and the motion vectors. Because the residual values tend to be smaller, they require fewer bits to encode when passed through the entropy encoder 48.

The location of the portion of the preceding frame is determined by a motion vector, which is determined by the motion prediction algorithm in the inter prediction module 46.

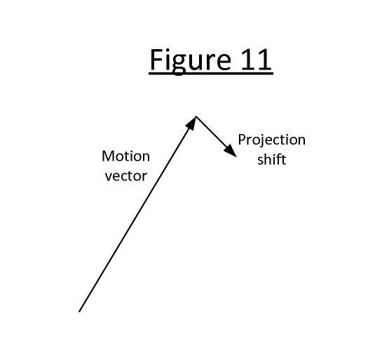

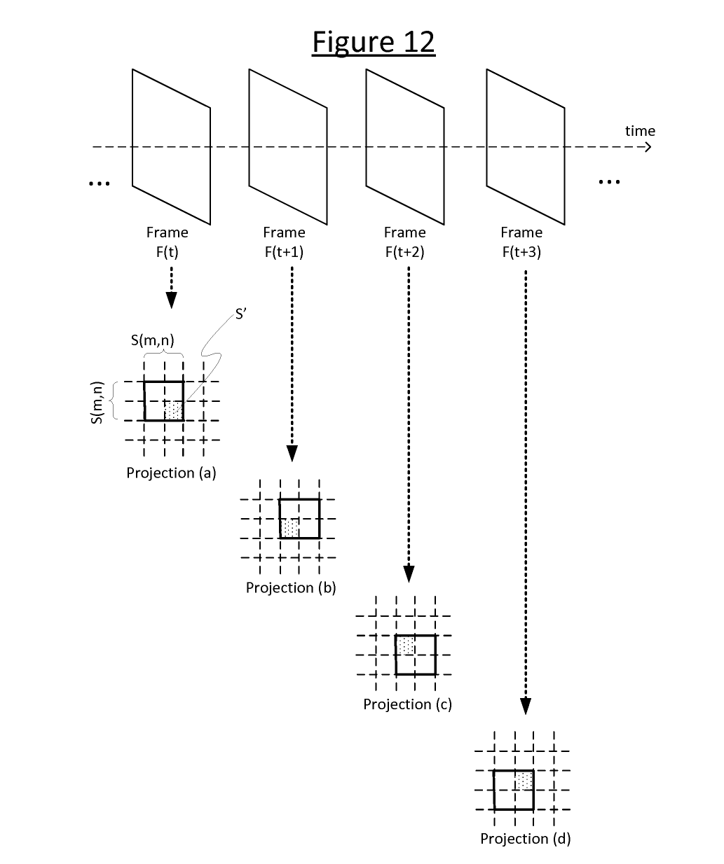

In embodiments a block from one projection of one frame is predicted from a different projection having a different shift in a preceding frame. E.g. referring to FIG. 12, a block from projection (b), (c) and/or (d) of frames F(t+1), F(t+2) and/or F(t+3) respectively is predicted from a portion of projection (a) in frame F(t−1). Thus the encoder only needs to encode all but one of the projections in terms of a residual relative to the base projection. In such cases of prediction between different projections, the motion vector representing the motion between frames may be added to a vector representing the shift between the different projections, in order to obtain the correct prediction. This is illustrated schematically in FIG. 11.

Alternatively, the motion prediction may be between two corresponding projections from different frames, i.e. between projections having the same shift within their respective frames. For example referring to FIG. 12, blocks from projection (a) of Frame F(t+4) may be predicted from projection (a) of frame F(t), blocks from projection (b) of Frame F(t+5) may be predicted from projection (b) of frame F(t), and so forth (in this example the pattern repeats every 4 projections). In this case the shift is the same between frames used in any given prediction, and so no addition of the kind shown in FIG. 11 is needed. Another reason such embodiments may be used is that there need be no dependency between streams carrying different projections, so a stream carrying one or more of the projections can dropped and the remaining stream (s) can still be decoded independently.

If using inter prediction, the transformed, quantized samples are subject instead to the intra prediction module 45. In this case the transformed, quantized coefficients from a block of the current frame F(t) are encoded relative to a block within the same frame, typically a neighbouring block. The encoder then only needs to transmit the residual difference between the predicted version of the block and the neighbouring block. Again, because the residual values tend to be smaller they require fewer bits to encode when passed through the entropy encoder 48. The intra prediction module 45 predicts between blocks of the same projection in the same frame.

The prediction may advantageously present more opportunities for reducing the size of the residual, because corresponding counterpart samples from the different projections will tend to be similar and therefore result in a small residual.

Once encoded by the intra prediction coding module 45 or inter prediction coding module 46, the blocks of samples of the different projections are passed to the entropy encoder 48 where they are subject to a further, lossless encoding stage. The encoded video output by the entropy encoder 48 is then passed to the transmitter 18, which transmits the encoded video 33 to the receiver 28 of the receiving terminal 22 over the network 32, for example a packet-based network such as the Internet.

FIG. 7 gives a schematic block diagram of a decoding system that may be stored and run on the receiving terminal 22. The decoding system comprises a decoder 50 and a super resolution module 70, for example being implemented as modules of software (though the option of some or all of the functionality being implemented in dedicated hardware circuitry is not excluded). The decoder 50 has an input arranged to receive the encoded video from the receiver 28, and an output operatively coupled to the input of a super resolution module 70. The super resolution module 70 has an output arranged to supply decoded video to the screen 25.

FIG. 5 gives a schematic block diagram of the decoder 50. The decoder 50 comprises an entropy decoder 58, and intra prediction decoding module 55 and an inter prediction (motion prediction) decoding module 54, a reverse quantization module 54 and a reverse transform module 52. The entropy decoder 58 is operatively coupled to the input from the receiver 28. Each of the intra prediction decoding module 55 and inter prediction decoding module 56 is operatively coupled to the entropy decoder 58. The reverse quantization module 54 is operatively coupled to the intra and inter prediction decoding modules 55 and 56, and the reverse transform module 52 is operatively coupled to the reverse quantization module 54. The reverse transform module is operatively coupled to supply the output to the super resolution module 70.

In operation, each projection may be individually passed through the decoder 50 and treated as a separate stream.

The entropy decoder 58 performs a lossless decoding operation on each projection of the encoded video signal 33 in accordance with entropy coding techniques, and passes the resulting output to either the intra prediction decoding module 55 or the inter prediction decoding module 56 for further decoding, depending on whether intra prediction or inter prediction (motion prediction) was used in the encoding.

If inter prediction was used, the inter prediction module 56 uses the motion vector received in the encoded signal to predict a block from one frame based on a portion of a preceding frame, between the projections of the frames. If needed the motion vector and shift may be added as shown in FIG. 11. However, in embodiments this is not needed if the motion prediction is between frames having the same projection, e.g. between frames F(f) and F(t+4) and so forth if the shift pattern is four frames long.

If intra prediction was used, the intra prediction module 55 predicts a block from another block in the same frame.

The decoded projections are then passed through the reverse quantization module 54 where the quantized levels are converted onto a de-quantized scale, and the reverse transform module 52 where the de-quantized coefficients are converted from the transform domain into samples in the spatial domain. The dequantized, reverse transformed samples are supplied on to the super resolution module 70.

The super resolution module 70 uses the lower resolution samples from the different projections of the same frame to “stich together” a higher resolution version of the video image represented by the signal being decoded. As discussed, this can be achieved by taking overlapping lower resolution samples from the different projections from the different frames in the sequence, and generating a higher resolution sample corresponding to the region of overlap. The value of the higher resolution sample is found by extrapolating between the values of the overlapping lower resolution samples, e.g. by talking an average. E.g. see the shaded region overlapped by four lower resolution samples S from the four different projections (a) to (d) in FIG. 12 from frames F(t) to F(t+3) respectively. This allows a higher resolution sample S′ to be reconstructed at the decoder side.

The process will involve some degradation. For example referring to FIG. 12, each lower resolution sample represents four higher resolution samples of the original input frame, and the four projections with shifts of (0,0); (0, +½); (+½, +½); and (+½, 0) are spread out in time over different successive frames. In this case a unique combination of four lower resolution samples from four different projections is available at the decoder for every higher resolution sample to be recreated, and the higher resolution sample size reconstructed at the decoder side may be the same as the higher resolution sample size of the original input frame at the encoder side. However, the data used to achieve this resolution is spread out over time so that information is lost in the time domain. Another example occurs if only two projections are created e.g. with shifts of (0,0) and (+½, +½). In this case information is also lost. However, in either case the loss may be considered tolerable perceptually. Generally the higher resolution samples reconstructed at the decoder side need not be as high as the higher resolution sample size of the original input frame at the encoder side

This process is performed over all frames frames in the video signal being decoded. Different projections are provided in different frames as in FIG. 12, the decoder repeats the pattern over multiple sequences of frames. The reconstructed, higher resolution frames output for supply to the screen 25 so that the video is displayed to the user of the receiving terminal 22.

In embodiments the different projections may be transmitted over the network 32 from the transmitting terminal 12 to the receiving terminal 22 in separate packet streams. Thus each projection is transmitted in a separate set of packets making up the respective stream, for example being distinguished by a separate stream identifier for each stream included in the packets of that stream. At least one of the streams is independently encoded, i.e. using a self-contained encoding, not relative to any others of the streams carrying the other projections. In embodiments more or all of the streams may be encoded in this way.

FIG. 8 gives a schematic representation of an encoded video signal 33 as would be transmitted from the encoder running on the transmitting terminal 12 to the decoder running on the receiving terminal 22. The encoded video signal 33 comprises a plurality of encoded, quantized samples for each block. Further, the encoded video signal is divided into separate streams 33a, 33b, 33c and 33d carrying the different projections (a), (b), (c), (d) respectively. In one example application, the encoded video signal may be transmitted as part of a live (real-time) video phone call such as a VoIP call between the transmitting and receiving terminals 12, 22 (VoIP calls can also include video).

An advantage of transmitting in different streams is that one or more of the streams can be dropped, or packets of those streams dropped, and it is still possible to decode at least a lower resolution version of the video from one of the remaining projections, or potentially a higher (but not full) resolution version from a subset of remaining projections. The streams or packets may be deliberately dropped, or may be lost in transmission.

Projections may be dropped at various stages of transmission for various reasons. Projections may be dropped by the transmitting terminal 12. It may be configured to do this in response to feedback from the receiving terminal 22 that there are insufficient resources at the receiving terminal (e.g. insufficient processing cycles or downlink bandwidth) to handle a full or higher resolution version of the video, or that a full or higher resolution is not necessarily required by a user of the receiving terminal; or in response to feedback from the network 32 that there are insufficient resources at one or more elements of the network to handle a full or higher resolution version of the video, e.g. there is network congestion such that one or more routers have packet queues full enough that they discard packets or whole streams, or an intermediate server has insufficient processing resources or up or downlink bandwidth. Another case of dropping may occur where the transmitting terminal 12 does not have enough resources to encode at a full or higher resolution (e.g. insufficient processing cycles or uplink bandwidth). Alternatively or additionally, one or more of the streams carrying the different projections may be dropped by an intermediate element of the network 32 such as a router or intermediate server, in response to network conditions (e.g. congestion) or information from the receiving terminal 22 that there are insufficient resources to handle a full or higher resolution or that such resolution is not necessarily required at the receiving terminal 22.

For example, say a signal is split into four projections (a) to (d) at the encoder side, each in a separate stream. If the receiving terminal 22 receives all four streams, the decoding system can recreate a full resolution version of that frame. If however one or more streams are dropped, e.g. the streams carrying projections (b) and (d), the decoding system can still reconstruct a higher (but not full) resolution version of the video by extrapolating only between overlapping samples of the projections (a) and (c) from the remaining streams. Alternatively if only one stream remains, e.g. carrying projection (a), this can be used alone to display only a lower resolution version of the frame. Thus there may be provided a new form of layered or scaled coding based on splitting a video signal into different projections.

In embodiments the encoder uses a predetermined shift pattern that is assumed by both the encoder side and decoder side without having to be signalled between them, over the network, e.g. both being pre-programmed to use a pattern such as (0,0); (0, +½); (+½, +½); (+½, 0) as described above in relation to FIG. 12. In this case it is not necessary to signal the shift pattern to the decoder side in the encoded stream or streams. An advantage of this is that there is no concern that a packet or stream containing the indication of a shift might be lost or dropped, which would otherwise cause a breakdown in the reconstruction scheme at the decoder. However, using a predetermined pattern is not essential and in alternative embodiments an indication of a shift or shift pattern could be signalled to the decoder side.

According to schemes as exemplified above, a super resolution based technique may advantageously be used to reduce the number of bits per unit time required to signal encoded video, and/or to provide a new form of layered coding.

However, as mentioned previously, a problem may be associated with such schemes in that a rounding error is introduced into the motion vector when using inter frame prediction coding based on motion prediction. This problem is illustrated by way of example in FIGS. 9 and 10.

FIG. 9 shows a block B being encoded. The block B comprises a plurality of lower resolution samples S formed by combining respective groups of higher resolution samples S′. For illustrative purposes, in this example each block B comprises a respective 2×2 square of four lower resolution samples, and each lower resolution is formed from a respective 2×2 square of higher resolution samples S′. However, larger block sizes may be used (e.g. 4×4, 8×8), and other sizes of lower resolution sample are also possible (e.g. 4×4).

The block B is predicted from a portion of another frame typically a preceding frame. The portion is typically the same size as the block but is not constrained to being co-located with any one whole block of the block structure (i.e. generally can be offset by a fraction of a block).

in embodiments, the inter frame prediction is performed between the projections of the frames having the same position within the sequence of projections. In the example of FIG. 12 the pattern repeats every four frames, so the sequence length (n) is four frames long. In this case the motion prediction for a given projection or stream may be only between every fourth frame, or between frames an integer multiple of four frames apart; or more generally between frame F(t) and F(t+n) (or t+an integer multiple of n). So in FIG. 12 the motion prediction is performed only between frames reduced to a projection having the alignment of projection (a), only between frames reduced to a projection having the alignment of projection (b), only between frames reduced to a projection having the alignment of projection (c), and only between frames reduced to a projection having the alignment of projection (d). That is, the motion prediction is only between the same projection in different instances of the sequence. All the projections (a) may be considered to form one set of projections, all the projections (b) another set, and so forth.

In embodiments each set of projections is carried in a separate stream, each having its own self-contained set of motion predictions. So in the example of FIGS. 8 and 12, all the projections from position (a) in the sequence are encoded into their own respective stream 33a, all the projections from position (b) in the sequence are encoded into a separate respective stream 33b, all the projections from position (c) in the sequence are encoded into another separate respective stream 33c, and all the projections from position (d) in the sequence are encoded into yet another separate respective stream 33d. This way if the stream carrying any one projection is lost (deliberately or otherwise), each remaining stream may still be independently decodable as it does not rely on the lost information.

The motion prediction module 46 at the encoder 40 generates a motion vector representing a spatial offset in the plane of the video image between the block B and the portion of the preceding frame relative to which it is predicted. As will be familiar to a person skilled in the art, the location of the portion from which the block is predicted is selected so as to minimise the residual difference between the block and the portion, i.e. the closest match.

The motion prediction module 46 has access to the higher resolution samples S′ (represented by the lower arrow in FIG. 4). Thus the motion prediction module 46 initially determines a “true” motion vector m′ that is based on the higher resolution version of the image, on the higher resolution scale. That is to say, represented in units of the higher resolution sample size.

For signalling in the stream of a given one of the projections, the motion vector is then scaled down based on the lower resolution version of the image represented by the projection, onto the lower resolution scale. That is to say, represented in units of the lower resolution sample size. The scaled down motion vector m represents the same physical distance, but on a lower resolution (coarser) scale.

If the higher resolution motion vector m′ is determined to be (x′, y′) higher resolution samples in the horizontal and vertical directions respectively, and the lower resolution samples are each f by f higher resolution samples in size such that the shift between projections is 1/f of a lower resolution pixel, then the vector will be scaled down by a factor f on the horizontal and vertical axes. This lower resolution vector m, e.g. referred to by coordinates (x, y), will equal (x′/f, y′/f) rounded to the accuracy of the motion prediction algorithm being used.

For example if the higher resolution motion vector m′ is determined to be (+10, −9) higher resolution samples in the horizontal and vertical directions respectively, and the lower resolution samples are each 2×2 higher resolution samples in size such that the shift between projections is half a lower resolution pixel, then the vector will be scaled down by a factor of two on the horizontal and vertical axes, which would be (+5, −4.5).

However, there will be a rounding error since the lower resolution version of the motion vector is expressed on a scale that is two (or more generally f) times coarser than the higher resolution version of the motion vector. Therefore in the example given, say the motion prediction algorithm operates in whole sample sized units, the lower resolution motion vector m may be rounded to (+5, −4) or (+5, −4.5).

This is repeated over each block of the frame. The motion vector for each predicted block is signalled to the decoder 50 on the receiving terminal 22 in the encoded bit stream or streams 33.

At the decoder side, the inter frame prediction module 56 in the decoder 50 then knows from the signalled information that the block B is predicted from a portion that is offset by (x, y) lower resolution samples, e.g. (+5, −4). It uses this information to predict the block B of lower resolution samples in one frame, e.g. F(t+4) or F(t+n), from a portion offset by that amount in another frame, e.g. F(t).

The scaled-down motion vector may be desired if it is intended that the frames of only a single projection are to be independently decodable as a stand-alone stream or signal, i.e. so any one set of projections is stand-alone version of the signal with the option but not the necessity of being combined with other sets of projections to obtain a higher resolution. E.g. say only the one stream carrying the projections of type (a) in the sequence is received. In this case the decoder need not even necessarily know that there were other streams from which it could have recreated a higher resolution, and it just sees the received stream as a single low resolution stream. In this case it will be desirable for the received motion vector to be represented on the same scale as the lower resolution samples, and the decoder thus has the option to treat it as en encoded signal in its own right without having to scale up to the higher resolution unless that is desired or available.

However, there remains the issue that the rounding error will propagate as motion vectors are cumulatively summed over several inter-frame predictions over many frames. This is illustrated schematically in FIG. 10. With each successive prediction from one frame to the next (for the projection or stream in question), the error resulting from the rounding will get increasing worse at the decoder.

To address this, the motion prediction module 46 in the encoder 40 is configured to identify the rounding error and signal this to the decoder 50 on the receiving terminal 22, for example including it as side information in the relevant encoded bit stream. It is advantageous to signal the rounding error since at the decoder the motion estimation may be assumed to have been done at the higher resolution. In this case the decoder will have to use the high resolution motion vectors to perform correct reconstruction.

For example, if the lower resolution sample size is 2×2 higher resolution samples, such that the shift between projections is half a (lower resolution) pixel, then the rounding error can be expressed as a single one-bit remainder 0 or 1 in each of the horizontal and vertical directions. If the lower resolution sample size is 4×4 higher resolution samples, such that the shift between projections is a quarter of a (lower resolution) pixel, then the remainder can be expressed using two bits 00, 01, 10 or 11 in each of the horizontal and vertical directions. Thus the rounding error can be preserved with only a few extra bits in the encoded bit stream.

At the decoder 50, the motion prediction module 56 then sums the remainder with the lower resolution motion vector m, and uses this to obtain a more accurate version of the vector. This in turn is used to predict the block B. For example in the half-pixel shift case, the decoder determines that the rounding error was 0 or 1 times half a lower resolution sample. E.g. if the received motion vector m is (+5, −4) lower resolution samples and the rounding error is (0, 1), the reconstructed higher resolution motion vector will be (+5, −4.5) lower resolution samples—or a fully recreated (+10, −9) scaled up into the higher resolution scale (rather than +10, −8). N.B. the decoder may be aware of whether the encoder works by rounding up or down, e.g. the decoder being pre-programmed on that basis, so that the summing will comprises adding or subtracting the remainder as appropriate. Alternatively the sign could be signalled. Note also that a motion prediction algorithm can be capable of predicting from non-integer sample offsets, so even if expressed in terms of lower resolution samples an accuracy of 4.5 or the like may be useful.

The encoder-decoder system can therefore benefit from the ability to divide a video signal into different independently decodable lower resolution projections or streams, but without incurring the error propagation due to rounding of the motion vector.

It will be appreciated that the above embodiments have been described only by way of example.

Note that the higher resolution motion vector m′ being represented on a scale of the higher resolution samples, i.e. in units of the higher resolution samples, does not necessarily mean it is constrained to being a whole integer number of such samples. Similarly the lower resolution motion vector m being represented on a scale of the lower resolution samples, i.e. in units of the lower resolution samples, does not necessarily mean it is constrained to being a whole integer number of such samples. For example some motion prediction algorithms allow motion vectors expressed in terms of half a sample. In this case the higher resolution vector m′ could be (+10, −9.5) higher resolution samples. Scaled down by a factor of two this would be (+5, −4.25), except that if the same motion prediction algorithm at the encoder still only allows half samples then this will be rounded to (+5, +4) or (+5, −4.5). In such cases it is still beneficial to signal the rounding error.

The various embodiments are not limited to lower resolutions samples formed from 2×2 or 4×4 samples corresponding samples nor any particular number, nor to square or rectangular samples nor any particular shape of sample. The grid structure used to form the lower resolution samples is not limited to being a square or rectangular grid, and other forms of grid are possible. Nor need the grid structure define uniformly sized or shaped samples. As long as there is an overlap between two or more lower resolution samples from two or more different projections, a higher resolution sample can be found from an intersection of lower resolution samples.

In embodiments the encoding is lossless. This may be achieved by preserving edge samples, i.e. explicitly encoding and sending the individual, higher-resolution samples from the edges of each frame in addition to the lower-resolution projections (edge samples cannot be fully reconstructed using the super resolution technique discussed above). Alternatively the edge samples need not be preserved in this manner. Instead the super resolution based technique of splitting a video into projections may be applied only to a portion of a frame (some but not all of the frame) in the interior of the frame, using more conventional coding for regions around the edges. This may also be lossless.

In other embodiments, the encoding need not be lossless—for example some degradation at frame edges may be tolerated.

The various embodiments can be implemented as an intrinsic part of an encoder or decoder, e.g. incorporated as an update to an H.264 or H.265 standard, or as a pre-processing and post-processing stage, e.g. as an add-on to an H.264 or H.265 standard. Further, the various embodiments are not limited to VoIP communications or communications over any particular kind of network, but could be used in any network capable of communicating digital data, or in a system for storing encoded data on a tangible storage medium.

Generally, any of the functions described herein can be implemented using software, firmware, hardware (e.g., fixed logic circuitry), or a combination of these implementations. The terms “module,” “functionality,” “component” and “logic” as used herein generally represent software, firmware, hardware, or a combination thereof. In the case of a software implementation, the module, functionality, or logic represents program code that performs specified tasks when executed on a processor (e.g. CPU or CPUs). The program code can be stored in one or more computer readable memory devices. The features of the techniques described below are platform-independent, meaning that the techniques may be implemented on a variety of commercial computing platforms having a variety of processors.

For example, the user terminals may also include an entity (e.g. software) that causes hardware of the user terminals to perform operations, e.g., processors functional blocks, and so on. For example, the user terminals may include a tangible, computer-readable medium that may be configured to maintain instructions that cause the user terminals, and more particularly the operating system and associated hardware of the user terminals to perform operations. Thus, the instructions function to configure the operating system and associated hardware to perform the operations and in this way result in transformation of the operating system and associated hardware to perform functions. The instructions may be provided by the computer-readable medium to the user terminals through a variety of different configurations.

One such configuration of a computer-readable medium is signal bearing medium and thus is configured to transmit the instructions (e.g. as a carrier wave) to the computing device, such as via a network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may us magnetic, optical, and other techniques to store instructions and other data.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A transmitting terminal comprising:
an input for receiving a video signal comprising a plurality of frames of a video image, each frame comprising a plurality of higher resolution samples;
a projection generator configured to generate a different respective projection of each of a sequence of said frames, each projection comprising a plurality of lower resolution samples, wherein the lower resolution samples of the different projections represent different but overlapping groups of the higher resolution samples which overlap spatially in a plane of the video image;
an encoder arranged to encode the video signal into one or more encoded streams; and
a transmitter arranged to transmit the one or more encoded streams to a receiving terminal over a network;
wherein the encoder is configured to perform inter frame prediction coding between the projections of different ones of the frames based on a motion vector for each prediction, to scale down the motion vector from a higher resolution scale corresponding to the higher resolution samples to a lower resolution scale corresponding to the lower resolution samples, to determine an indication of a rounding error resulting from said scaling, and to signal the indication of the rounding error to the receiving terminal.

2. The transmitting terminal of claim 1, wherein the encoder is configured to signal the rounding error as side information in at least one of the one or more encoded streams.

3. The transmitting terminal of claim 1, wherein the projection of each of said sequence of frames is a respective one of a pattern of projections having different spatial alignments in the plane of the video image, wherein said pattern repeats over successive instances of said sequence of frames.

4. The transmitting terminal of claim 3, wherein the inter frame prediction is between projections having a same spatial alignment within the plane of the video image but from different instances of said sequence.

5. The transmitting terminal of claim 4, wherein the pattern comprises at least a first projection having a first spatial alignment within the plane of the video image, and a second projection having a second spatial alignment within the plane of the video image; and said inter frame prediction is between the first projections of different instances of the sequence, and between the second projections of different instances of the sequence.

6. The transmitting terminal of claim 4, wherein:
the pattern comprises at least a first projection having a first spatial alignment within the plane of the video image, and a second projection having a second spatial alignment within the plane of the video image, a third projection having a third spatial alignment within the plane of the video image, and a fourth projection having a fourth spatial alignment within the plane of the video image; and
said inter frame prediction is between the first projections of different instances of the sequence, between the second projections of different instances of the sequence, between the third projections of different instances of the sequence, and between the fourth projections of different instances of the sequence.

7. The transmitting terminal of claim 1, wherein the encoder is configured to encode the video signal by encoding the different projections into separate respective encoded streams; and
the transmitter is configured to transmit each of the separate encoded streams to the receiving terminal over a network.

8. The transmitting terminal of claim 3, wherein:
the inter prediction is between projections having a same spatial alignment within the plane of the video image but from different instances of said sequence;
the encoder is configured to encode the video signal by encoding the projections having the same spatial alignment into a same respective encoded stream, with the projections having different spatial alignments being encoded into separate respective encoded streams; and
the transmitter is configured to transmit each of the separate encoded streams to the receiving terminal over a network.

9. The transmitting terminal of claim 8, wherein:
the pattern comprises at least a first projection having a first spatial alignment within the plane of the video image, and a second projection having a second spatial alignment within the plane of the video image;
said inter frame prediction is between the first projections of different instances of the sequence, and between the second projections of different instances of the sequence;
the encoder is configured to encode the video signal by encoding the first projections into a first respective encoded stream, and the second projections into a second respective encoded stream separate from the first stream; and
the transmitter is configured to transmit each of the first and second encoded streams to the receiving terminal over a network

10. The transmitting terminal of claim 8, wherein:
the pattern comprises at least a first projection having a first spatial alignment within the plane of the video image, and a second projection having a second spatial alignment within the plane of the video image, a third projection having a third spatial alignment within the plane of the video image, and a fourth projection having a fourth spatial alignment within the plane of the video image;
said inter frame prediction is between the first projections of different instances of the sequence, between the second projections of different instances of the sequence, between the third projections of different instances of the sequence, and between the fourth projections of different instances of the sequence;
the encoder is configured to encode the video signal by encoding the first projections into a first respective encoded stream, the second projections into a second respective encoded stream separate from the first stream, the third projections into a third respective encoded stream separate from the first and second encoded streams, and the fourth projections into a fourth respective stream separate from the first, second and third encoded streams; and
the transmitter is configured to transmit each of the first, second, third and fourth encoded streams to the receiving terminal over a network

11. The transmitting terminal of claim 3, wherein said pattern is predetermined, not being signalled in any of the streams from the encoding system to the decoding system.

12. The transmitting terminal of claim 1, wherein the encoder comprises an entropy encoder arranged to further encode the one or more encoded streams following the inter frame prediction coding.

13. The transmitting terminal of claim 1, wherein the lower resolution samples are defined by a grid structure, and the projection generator is configured to generate the projections by applying one or more different spatial shifts to the grid structure, each shift being by a fraction of one of the lower resolution samples.

14. The transmitting terminal of claim 3, wherein the projection generator is configured to apply the shifts according to a predetermined shift pattern, not being signalled in any of the one or more encoded streams from the encoding system to the decoding system.

15. The transmitting terminal of claim 8, wherein the separate streams include different respective stream identifiers.

16. The transmitting terminal of claim 8, wherein the network is a packet-based network, each of the separate streams comprising a separate set of packets.

17. The transmitting terminal of claim 16, wherein the packets of each set each comprise an identifier identifying the stream to which the packet belongs.

18. The transmitting terminal of claim 1, wherein the encoder and transmitter are arranged to encode and transmit the streams dynamically as part of a live video call.

19. A computer program product for decoding a video signal comprising a plurality of frames of a video image, the computer program product being embodied on a computer-readable storage medium and comprising code configured so as when executed on a receiving terminal to perform operations comprising:
receiving a video signal from a transmitting terminal over a network, the video signal comprising multiple different projections of the video image, each projection comprising a plurality of lower resolution samples wherein the lower resolution samples of the different projections represent different but overlapping portions which overlap spatially in a plane of the video image;
decoding the video signal so as to decode the projections;
generating higher resolution samples representing the video image at a higher resolution by, for each higher resolution sample thus generated, forming the higher resolution sample from a region of overlap between ones of the lower resolution samples from the different projections; and
outputting the video signal to a screen at the higher resolution following generation from the projections;
wherein the decoding comprises inter frame prediction between the projections of different ones of the frames based on a motion vector received from the transmitting terminal for each prediction, and scaling up the motion vector for use in the prediction from a lower resolution scale corresponding to the lower resolution samples to a higher resolution scale corresponding to the higher resolution samples; and
wherein the code is further configured to receive an indication of a rounding error from said transmitting terminal, and to incorporate the rounding error when performing said scaling up of the motion vector.

20. A method comprising:
receiving as an input a video signal comprising a plurality of frames of a video image, each frame comprising a plurality of higher resolution samples;
generating a different respective projection of each of a sequence of said frames, each projection comprising a plurality of lower resolution samples, wherein the lower resolution samples of the different projections represent different but overlapping groups of the higher resolution samples which overlap spatially in a plane of the video image;
encoding the video signal into one or more encoded streams and transmitting the one or more encoded streams to a receiving terminal over a network, wherein encoding comprises inter frame prediction coding between the projections of different ones of the frames based on a motion vector for each prediction, the motion vector being scaled down from a higher resolution scale corresponding to the higher resolution samples to a lower resolution scale corresponding to the lower resolution samples, wherein the encoding further comprises determining an indication of a rounding error resulting from said scaling and signalling the indication of the rounding error to the receiving terminal;
at the receiving terminal, decoding the one or more encoded video streams so as to decode the projections, wherein the decoding comprises inter frame prediction between the projections of different ones of the frames based on the motion vector received from the transmitting terminal for each prediction, and scaling up the motion vector for use in the prediction from the lower resolution scale to the higher resolution scale;
generating higher resolution samples representing the video image at a higher resolution by, for each higher resolution sample thus generated, forming the higher resolution sample from a region of overlap between ones of the lower resolution samples from the different projections; and
outputting the video signal to a screen at the higher resolution following generation from the projections;
wherein the method further comprises receiving an indication of a rounding error from said transmitting terminal, and incorporating the rounding error when performing said scaling up of the motion vector.
